(19) United States
(12) Patent Application Publication
(10) Pub. No.: US 2024/0062127 A1
(43) Pub. Date: Feb. 22, 2024

(54) IMAGE FORMING APPARATUS AND CONTROL METHOD

(71) Applicant: Toshiba Tec Kabushiki Kaisha, Tokyo (JP)

(72) Inventor: Jin KAMADA, Izunokuni Shizuoka (JP)

(73) Assignee: Toshiba Tec Kabushiki Kaisha, Tokyo (JP)

(21) Appl. No.: 18/366,419

(22) Filed: Aug. 7, 2023

(30) Foreign Application Priority Data
Aug. 19, 2022 (JP) 2022-131141

(51) Int. Cl. G06Q 10/0631; G06Q 10/101

(52) U.S. Cl. CPC G06Q 10/063114; G06Q 10/101

(57) ABSTRACT

A technique suitable for a work-from-home employee to request work to an office employee includes an image forming apparatus The image forming apparatus includes a receiver for receiving request information for requesting the work from the work-from-home employee to the office employee working in a business office, a display controller configured to display work indicated by the request information received by the receiver, and a selector that receives a selection of work to be performed by the office employee among the work indicated by the request information received by the receiver.

### CROSS-REFERENCE TO RELATED APPLICATION

This application is based upon and claims the benefit of priority from Japanese Patent Application No. 2022-131141, filed on Aug. 19, 2022, the entire contents of which are incorporated herein by reference.

### FIELD

Embodiments described herein relate generally to an image forming apparatus and a control method.

### BACKGROUND

A work-from-home employee may need to perform work that can only be performed at a business office. In this case, an employee working in the business office (hereinafter, referred to as an “office employee”) may be requested to cover the work. Examples of a request method include a method in which the work-from-home employee contacts the office employee by using a communication tool or the like.

The method using the communication tool is to decide an office employee to ask for the work request and then contact the office employee. Therefore, it takes time to search for the office employee to ask, and if the asked office employee cannot perform the work, it takes time to search for a second office employee to ask and contact the second employee, which is inefficient.

In addition, some types of work can be performed by any office employee depending on the content of the work, but even in this case, it takes time and effort to search for a person to ask.

### DESCRIPTION OF THE DRAWINGS

FIG. 1 is a diagram showing a configuration of a work-from-home employee support system according to one embodiment;

FIG. 2 is an external view showing a configuration of an image forming apparatus according to one embodiment;

FIG. 3 is a diagram showing a configuration of a control system of the image forming apparatus according to one embodiment;

FIG. 4 is a diagram showing a functional configuration of the image forming apparatus according to one embodiment;

FIG. 5 is a diagram showing a screen 1010;

FIG. 6 is a diagram showing a screen 1020;

FIG. 7 is a diagram showing a screen 1030;

FIG. 8 is a diagram showing a screen 1040;

FIG. 9 is a diagram showing a screen 1050;

FIG. 10 is a diagram showing a screen 1060;

FIG. 11 is a diagram showing a screen 1070;

FIG. 12 is a diagram showing a screen 1080;

FIG. 13 is a diagram showing a screen 1090;

FIG. 14 is a diagram showing a screen 1100;

FIG. 15 is a flowchart showing a flow of processing of a mobile terminal 700;

FIG. 16 is a flowchart showing a flow of processing of the mobile terminal 700;

FIG. 17 is a flowchart showing a flow of processing of a request management server 600;

FIG. 18 is a flowchart showing a flow of processing of an image forming apparatus 100; and

FIG. 19 is a flowchart showing a flow of processing of the image forming apparatus 100.

### DETAILED DESCRIPTION

In general, according to one embodiment, a technique suitable for a work-from-home employee to request work to an office employee is provided.

An image forming apparatus according to an embodiment includes a reception unit (e.g., receiver, etc.), a display control unit (e.g., a display controller, a display control, etc.), and a selection unit (e.g., a selector, etc.). The receiver receives request information for requesting work from a work-from-home employee to an office employee working in a business office. The display control unit displays, on a display unit (e.g., a display, a screen, etc.), work indicated by the request information received by the receiver. The selector causes the office employee to select work to be performed by the office employee among the work indicated by the request information received by the receiver.

In an image forming apparatus according to an embodiment, a technique suitable for a work-from-home employee to request work to an office employee can be provided. Hereinafter, the image forming apparatus according to the embodiment will be described in detail.

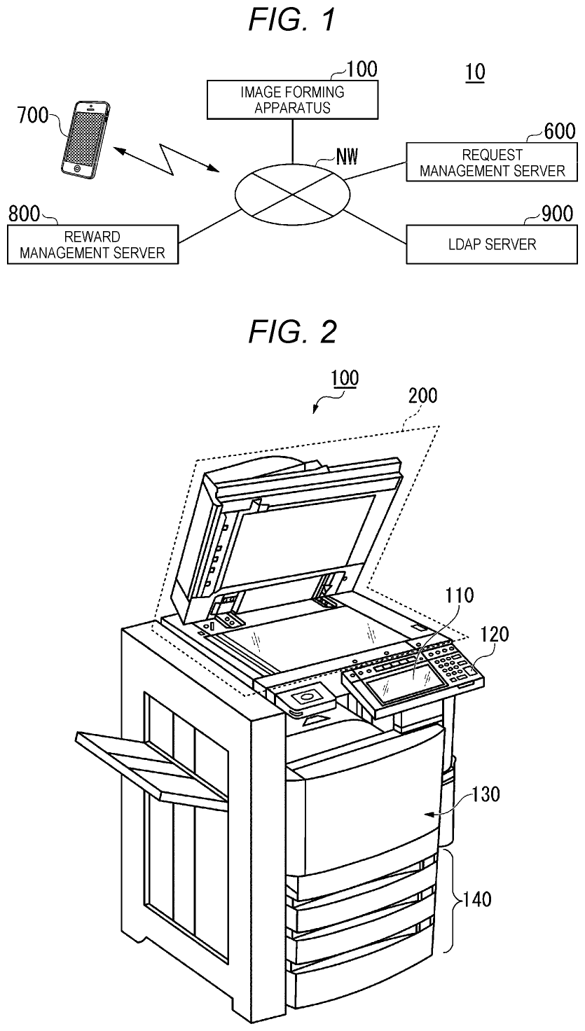

FIG. 1 is a diagram showing a configuration of a work-from-home employee support system 10 including an image forming apparatus 100 according to the present embodiment. In the following description, the “office employee” indicates an employee who works at a business office. Accordingly, the office employee is a person who can perform work at the business office.

The work-from-home employee support system 10 includes the image forming apparatus 100, a request management server 600, a mobile terminal 700, a reward management server 800, and a lightweight directory access protocol (LDAP) server 900 that are connected with one another via a network NW. The network NW includes the Internet, a mobile phone line, a LAN, and the like.

The image forming apparatus 100 is an image forming apparatus installed in the business office, and can be used by the office employee. Although only one image forming apparatus 100 is shown, one or more image forming apparatuses 100 may be provided. The mobile terminal 700 is a mobile terminal used by the work-from-home employee, and is, for example, a smartphone, a mobile device, and the like. The work-from-home employee requests work to the office employee by using the mobile terminal 700. Although only one mobile terminal 700 is shown, one or more mobile terminals 700 may be provided. The request management server 600 is a server that manages the work request to the office employee. Communication related to a request between the mobile terminal 700 and the image forming apparatus 100 is performed via the request management server 600. The LDAP server 900 is used for, for example, authentication of the office employee. The reward management server 800 manages a reward to be given to the office employee who completes the work.

In FIG. 1, the request management server 600 is an apparatus different from the image forming apparatus 100, but one or more functions of the request management server 600 may be incorporated into the image forming apparatus 100. If the function of the request management server 600 is incorporated into the image forming apparatus 100, in the following description, the “request management server 600” is interpreted as the “request management server 600 incorporated into the image forming apparatus 100”.

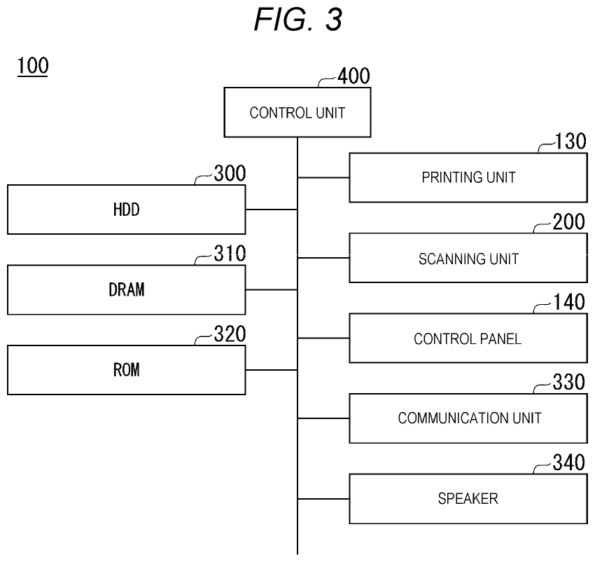

FIG. 2 is an external view showing an overall configuration example of the image forming apparatus 100 according to an embodiment. The image forming apparatus 100 is, for example, a multifunction machine. The image forming apparatus 100 includes a display 110, a control panel 120, a printer 130, a sheet storage unit 140, and a scanner 200. The image forming apparatus 100 further includes a controller 400 that controls the entire apparatus as shown in FIG. 3.

The image forming apparatus 100 forms an image on a sheet by using a developer. The developer is, for example, a toner. In the following description, the developer is a toner. The sheet is, for example, paper or label paper. The sheet may be any object the image forming apparatus 100 can form an image on a surface of (e.g., a sheet of paper, a label, etc.).

The display 110 is an image display device such as a liquid crystal display (LCD) or an organic electro luminescence (EL) display. The display 110 displays various types of information on the image forming apparatus 100. The display 110 is an example of a display unit.

The control panel 120 includes a plurality of buttons. The control panel 120 accepts operations of a user. The control panel 120 outputs a signal corresponding to an operation performed by the user to the controller 400 of the image forming apparatus 100. The display 110 and the control panel 120 may be configured as an integrated touch panel.

The printer 130 prints the image on the sheet based on image information generated by the scanner 200 or image information received via a network. The printer 130 prints the image by using the toner. The sheet on which the image is printed may be stored in the sheet storage unit 140, or may be fed manually. The sheet storage unit 140 stores the sheet used for the image formation in the printer 130.

The scanner 200 reads the image information to be read as brightness and darkness of light. The scanner 200 records the read image information. The recorded image information may be transmitted to another information processing apparatus via the network. The recorded image information may be formed on the sheet as the image by the printer 130.

FIG. 3 is a diagram showing a configuration of a control system of the image forming apparatus 100.

The image forming apparatus 100 includes the printing unit (e.g., printer, etc.) 130, the scanning unit (e.g., scanner, etc.) 200, the control panel 120, a communication unit (e.g., communicator, etc.) 330, a speaker 340, the control unit (e.g., controller, etc.) 400, a hard disk drive (HDD) 300, a dynamic random access memory (DRAM) 310, and a read only memory (ROM) 320. These units are connected via a system bus.

The controller 400 controls the units connected via the system bus. The ROM 320 stores various control programs necessary for the image forming apparatus 100 to operate. The ROM 320 stores programs for controlling an image forming operation and the like. The HDD 300 stores programs and data. Execution of the programs stored in the ROM 320 and the HDD 300 is controlled by the controller 400. The DRAM 310 is a buffer memory that temporarily stores data generated when the programs are executed.

The communication unit 330 is a device group for the image forming apparatus 100 to perform communication (communication using a wired LAN, a wireless LAN, a universal serial bus (USB), Bluetooth (registered trademark), or the like) with other devices. The speaker 340 outputs various sounds such as a beep sound.

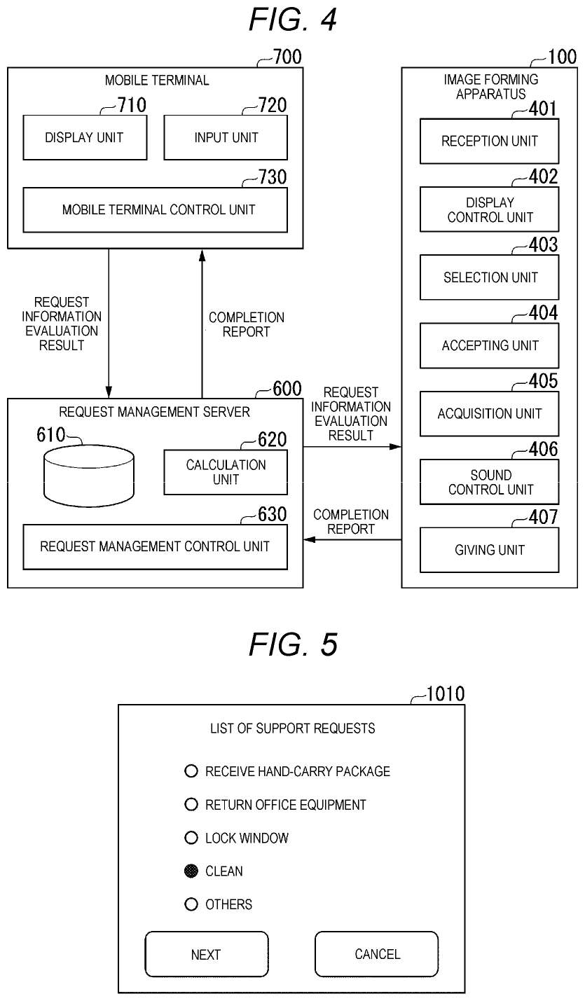

FIG. 4 is a diagram showing a functional configuration of the image forming apparatus 100. FIG. 4 shows functional configurations of the request management server 600 and the mobile terminal 700 in addition to the functional configuration of the image forming apparatus 100. Functions shown in FIG. 4 are implemented by, for example, a hardware processor such as a central processing unit (CPU) executing programs (software). A part or all of these components may be implemented by hardware (including circuit unit and circuitry) such as a large scale integration (LSI), an application specific integrated circuit (ASIC), a field-programmable gate array (FPGA), and a graphics processing unit (GPU), or may be implemented by cooperation of the software and the hardware. The programs may be stored in advance in a storage device (a storage device including a non-transitory storage medium) such as a hard disk drive (HDD), a solid state drive (SSD), or a flash memory, or may be stored in a detachable storage medium (a non-transitory storage medium) such as a DVD or a CD-ROM and installed by mounting the storage medium in a drive device.

The image forming apparatus 100 includes a reception unit (e.g., receiver, etc.) 401, a display control unit (e.g., display controller, etc.) 402, a selection unit (e.g., selector, etc.) 403, an accepting unit (e.g., acceptor, etc.) 404, an acquisition unit (e.g., acquirer, etc.) 405, and a sound control unit (e.g., sound controller, etc.) 406. The receiver 401 receives request information for requesting the work from the work-from-home employee to the office employee working in the business office. The display controller 402 displays the work indicated by the received request information on the display 110. The selector 403 causes the office employee to select the work to be performed by the office employee among the work indicated by the received request information.

The acceptor 404 accepts a completion report of the work selected by the selector 403. The acquirer 405 acquires an evaluation result obtained by evaluation performed by the work-from-home employee for the completion report accepted by the acceptor 404. A giving unit (e.g., a giver, etc.) 407 gives, according to the evaluation result, a profit to the office employee who completes the work.

The mobile terminal 700 includes a display unit (e.g., a display, a screen, etc.) 710, an input unit 720, and a mobile terminal control unit 730. The display 710 is implemented by, for example, an LCD or an organic EL. The input unit 720 is implemented by a touch panel or hard keys. The mobile terminal control unit 730 is implemented by an arithmetic device or a storage device, and controls the entire mobile terminal 700.

The request management server 600 includes a request management DB (database) 610, a calculation unit (e.g., a calculator, etc.) 620, and a request management controller 630. The request management DB stores information related to the request. The information related to the request includes information for specifying the mobile terminal 700 that is requesting the work, the request information, information for specifying the image forming apparatus 100 that receives the request information, information for specifying an office employee that performs (or completes) the requested work, the completion report, and the evaluation result. The request information includes information for specifying the requested work and information for specifying the mobile terminal 700 that requests the work.

The calculation unit 620 determines (e.g., calculates, etc.) when to instruct the image forming apparatus 100 to print the request information, and obtain a calculation result. The request management controller 630 is implemented by an arithmetic device or a storage device, and controls the entire request management server 600.

Based on the configuration described above, a flow of processing of the work-from-home employee support system 10 will be described by using a screen and the like.

An application for requesting the work (hereinafter, referred to as an “application”) is installed in the mobile terminal 700. The work-from-home employee launches a support request application. The application transmits an acquisition request of a support request item to the request management server 600. In the support request item, a work content to be requested is determined in advance, and a list of the work is indicated.

The request management server 600 returns the support request item to the application. The application displays a list of the acquired support request items on a screen. FIG. 5 is a diagram showing a screen 1010. The screen 1010 is an example of a screen showing a list of support request items displayed on the mobile terminal 700. In the screen 1010, the work-from-home employee can select work to be requested by using a radio button. “Others” shown on the screen 1010 is a radio button for inputting new work that is not default work. When “others” is selected, the mobile terminal 700 displays a screen for allowing the work-from-home employee to input what kind of work is to be requested. If the new work is input in this way, the input new work may be displayed as the default work.

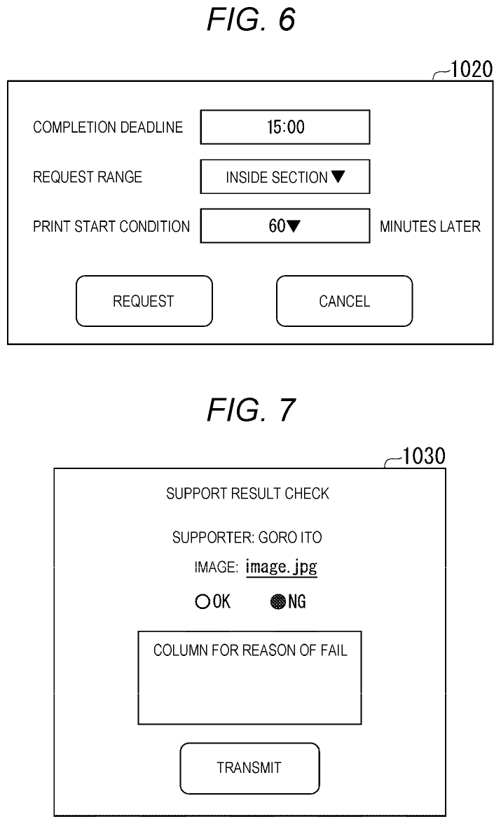

When the work-from-home employee touches “next” on the screen 1010, a screen 1020 shown in FIG. 6 is displayed. The screen 1010 is an example of a screen for the work-from-home employee to input details. Specifically, “completion deadline”, “request range”, and “print start condition” are included. “Completion deadline” indicates a deadline by which the work is completed. For example, as shown in FIG. 6, the deadline can be designated at a time such as 15:00.

“Request range” indicates a range of the image forming apparatus 100 that displays the request. For example, as shown in FIG. 6, the request range can be designated as the image forming apparatus 100 “inside section”. The request management server 600 stores in advance information capable of uniquely identifying the image forming apparatus 100 “inside section” in association with “inside section”, and transmits the request information to the associated image forming apparatus 100 when “inside section” is designated. The “request range” may be “on same floor”, “specific group”, or the like, in addition to “inside section”. “Print start condition” indicates a condition under which the work-from-home employee prints a request content in the image forming apparatus 100. As shown in FIG. 6, the print start condition can be designated at a time such as 60 minutes later. When the work-from-home employee touches “request” shown in FIG. 6, the application transmits the request information to the request management server 600.

The request management server 600 transmits the request information to the image forming apparatus 100 associated with the range designated by “request range”. If the function of the request management server 600 is incorporated in the specific image forming apparatus 100, information for transmitting the request information to the specific image forming apparatus 100 is preset in the mobile terminal 700. The mobile terminal 700 directly transmits the request information to the image forming apparatus 100 based on the preset information.

When receiving the request content, the request management server 600 assigns an ID capable of uniquely identifying the request information. Further, the request management server 600 performs calculation based on a print start condition of the request information, and sets a flag if it is necessary to start printing. Here, the flag may be a simple Boolean value for a condition that needs to be verified in the image forming apparatus 100, such as a screen state of the image forming apparatus 100. Alternatively, a character string for performing final condition determination by the image forming apparatus 100 may be used as the flag. Such a flag includes a condition such as whether to perform printing when the image forming apparatus 100 is in a sleep state, such as “printIfSleeping.”

Whether the printing is necessary may be determined based on information collected from another business office equipment installed in the business office where the image forming apparatus 100 is installed. If there is a flag, the request management server 600 transmits the flag to the image forming apparatus 100 together with the request information. If the function of the request management server 600 is provided in the image forming apparatus 100, if the image forming apparatus 100 itself is included in the “request range”, the request information or the like is transmitted by a message used inside the image forming apparatus 100.

Next, the image forming apparatus 100 that receives the request information will be described. In the following description, processing that requires identification of the office employee in the image forming apparatus 100 will also be described. In this case, the office employee logs in advance or performs processing after performing a log-in operation once. In either case, the image forming apparatus 100 authenticates the office employee by the LDAP server 900.

When receiving the request information, the image forming apparatus 100 outputs a reception sound (for example, a beep sound) from the speaker 340. Accordingly, the office employee who can hear the reception sound around the image forming apparatus 100 can recognize that the request information is received.

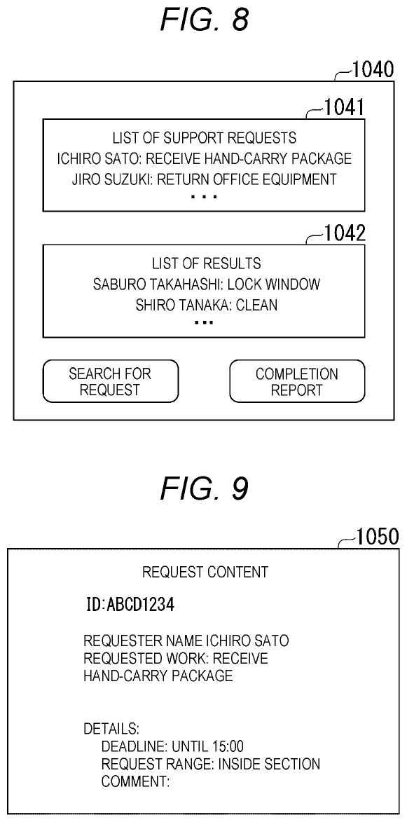

The image forming apparatus 100 displays the request information on the display 110. FIG. 8 is a diagram showing a screen 1040. The screen 1040 is an example of a screen display of the request information and the like. The screen 1040 includes a support request list display field 1041 showing a list of the received request information and a result list display field 1042. In the support request list display field 1041, information for specifying the work-from-home employee who makes the request (names in FIG. 8) and the work content are displayed. The result list display field 1042 shows a list of results obtained by evaluation performed by the work-from-home employee in response to a request in which the work is completed and the completion report is performed. In the result list display field 1042, the work content and the information for specifying the work-from-home employee who makes the request (names in FIG. 8) are displayed.

When receiving the flag, the image forming apparatus 100 prints the request information. At this time, in a case of a flag requiring determination such as the flag with a condition described above, the image forming apparatus 100 performs printing after performing the determination. For example, when the image forming apparatus 100 has already received one or more pieces of request information, the image forming apparatus 100 may immediately print the request information. The printing makes it easier for the office employee to recognize that a plurality pieces of request information are received compared to a case where the request information is displayed only in the support request list display field 1041.

“Search for request” displayed on the screen 1040 is a button for searching the request information. The request information can be searched by using the ID, the work-from-home employee who makes the request, the requested work, or the like as a key. Further, “completion report” displayed on the screen 1040 is a button for inputting completion of the requested work by the office employee. “Completion report” will be described later.

FIG. 9 is a diagram showing a sheet 1050 on which the request information is printed. The ID, a name of a requester, the requested work, and the details described above are printed on the sheet 1050. The office employee can use the printed ID to search the request information by touching “search for request” on the screen 1040.

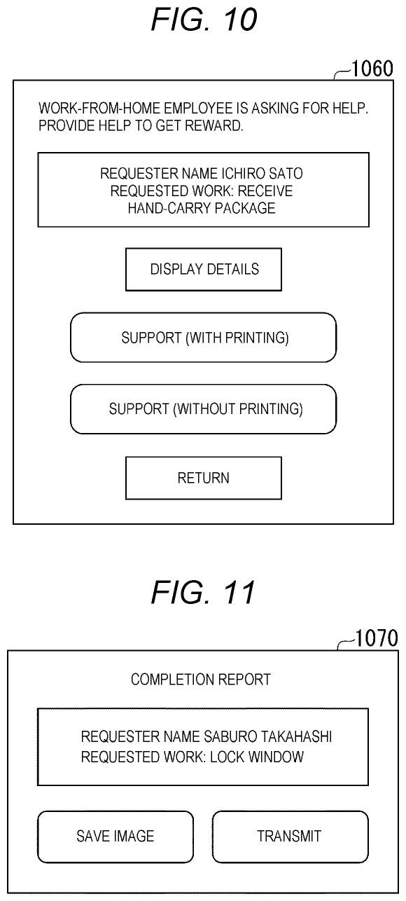

When the office employee touches the request information displayed in the support request list display field 1041 or searches for the request information with the ID printed on the sheet 1050 and touches the searched request information, the image forming apparatus 100 displays a screen 1060 in FIG. 10. On the screen 1060, “display details”, “support (with printing)”, “support (without printing)”, and “return” are displayed together with the name of the requester.

When “display details” is touched, the image forming apparatus 100 displays details of the request. When “support (with printing)” is touched, the image forming apparatus 100 determines that the office employee who touches “support (with printing)” accepts the support request, and prints the sheet 1050 shown in FIG. 9. By printing on the sheet, the office employee can refer to the request content and the details at any time. When “support (without printing)” is touched, the image forming apparatus 100 determines that the office employee who touches “support (without printing)” accepts the support request, but does not print. When “return” is touched, the image forming apparatus 100 displays a screen displayed before the screen 1060.

If support is received in this manner, the image forming apparatus 100 transmits the reception of support together with the ID to the request management server 600. The request management server 600 specifies the mobile terminal 700 of a request source based on the ID, and notifies the mobile terminal 700 that the request is received as status information.

If it takes time to actually perform the work, the office employee who receives the request may transmit work start waiting as the status information from the image forming apparatus 100 to the request management server 600. In this case, the request management server 600 transmits the received status information to the mobile terminal 700.

When completing the work, the office employee who receives the request touches “completion report” on the screen 1040 shown in FIG. 8. When “completion report” is touched, the image forming apparatus 100 displays a screen 1070 in FIG. 11. The screen 1070 is an example of a completion report screen. The screen 1070 displays “save image” and “transmit” in addition to the name of the requester and the work. “Save image” is a button for saving an image indicating an evidence photograph indicating that the work is completed. The evidence photograph is, for example, a photograph of an aspect in which the work is performed.

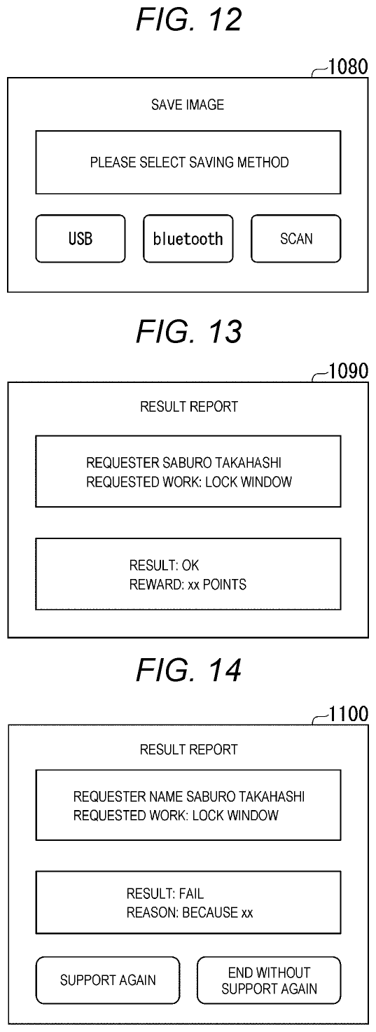

When the office employee touches “save image”, the image forming apparatus 100 displays a screen 1080 shown in FIG. 12. On the screen 1080, “USB”, “Bluetooth”, and “scan” are displayed to select an image saving method. When “USB” is touched, the image forming apparatus 100 acquires an image from, for example, a USB memory via the USB. When “Bluetooth” is touched, the image forming apparatus 100 acquires an image from, for example, a smartphone via Bluetooth. When “scan” is touched, the image forming apparatus 100 acquires an image by scanning a photograph placed on a platen glass by the scanner 200.

When acquiring and saving the image, the image forming apparatus 100 displays the screen 1070 in FIG. 11 again. When “transmit” is touched, the image forming apparatus 100 transmits the completion report to the request management server 600 together with the image. The saving of the image is not essential, and when “transmit” is touched, the image forming apparatus 100 transmits the completion report to the request management server 600 without the image. The transmission without the image may be used, for example, if evidence cannot be expressed by an image or if there is a sufficient trustworthy relationship between the work-from-home employee who makes the request and the office employee who completes the work.

When receiving the completion report, the request management server 600 transmits the completion report to the mobile terminal 700. When receiving the completion report, the mobile terminal 700 displays a screen 1030 shown in FIG. 7. The screen 1030 is a support result confirmation screen for displaying the completion report. The screen 1030 includes a name of a supporter who completes the work (“Goro Ito” in a case of FIG. 7) and a link (“image.jpg” in the case of FIG. 7) for displaying an image if there is an image. The work-from-home employee can view the evidence photograph by touching the link.

The screen 1030 includes radio buttons for the work-from-home employee to select an approval result (“OK” or “fail”). “OK” is selected if the work-from-home employee approves the completion of the work. “Fail” is selected if the work-from-home employee does not approve the completion of the work. When “fail” is selected, the mobile terminal 700 displays “column for reason of fail”. The work-from-home employee inputs a reason of fail. The work-from-home employee selects the radio button, inputs the reason as necessary, and touches “transmit”. When “transmit” is touched, the mobile terminal 700 transmits approval information (approval result, reason when the reason is input) to the request management server 600.

When receiving the approval information, the request management server 600 transmits the approval information to the image forming apparatus 100. When receiving the approval information, the image forming apparatus 100 displays a screen 1090 shown in FIG. 13 or a screen 1100 shown in FIG. 14. The screen 1090 is displayed when the work-from-home employee selects “OK”. The screen 1090 displays the name of the work-from-home employee who makes the request and the requested work. In addition, the approval result being OK and a reward (xx points) are also shown. The request management server 600 notifies the reward management server 800 of the generated reward.

On the other hand, the screen 1100 is a screen displayed when the work-from-home employee selects “fail”. The screen 1100 displays the name of the work-from-home employee who makes the request and the requested work. In addition, the approval result being fail and the reason are also shown. In addition, “support again” and “end without support again” are displayed. The office employee touches “support again” if to support again. When “support again” is touched, the image forming apparatus 100 notifies the request management server 600 that “support again” is touched. Accordingly, it is determined that the office employee accepts the support request in the same manner as when “support (with printing)” or “support (without printing)” is touched on the screen 1060.

If not to support again, the office employee touches “end without support again”. When “end without support again” is touched, the image forming apparatus 100 notifies the request management server 600 that “end without support again” is touched. Accordingly, the request management server 600 sets the request information into a state before support is provided. The image forming apparatus 100 displays the request information indicating ending without support again in the list of the request information again.

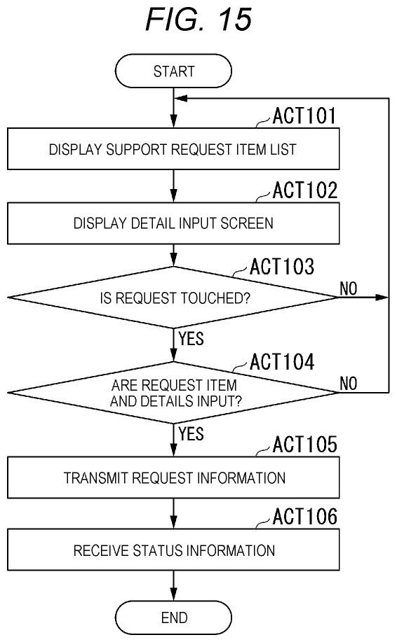

Next, a flow of processing will be described by using a flowchart. FIG. 15 is a flowchart showing a flow of processing of the mobile terminal 700. In FIG. 15, the mobile terminal 700 displays a support request item list of the screen 1010 (ACT 101). When “next” is touched on the screen 1010, a detail input screen of the screen 1020 is displayed (ACT 102). If “request” is touched on the screen 1020 (YES in ACT 103), the mobile terminal 700 determines whether a request item and the details are input (ACT 104). If the request item and the details are not input (NO in ACT 104), the mobile terminal 700 returns to ACT 101. If only the details are not input, the mobile terminal 700 may return to ACT 102.

If the request item and the details are input (YES in ACT 104), the mobile terminal 700 transmits the request information to the request management server 600 (ACT 105). Then, when the request is received, the status information is received from the request management server 600 (ACT 106), and the processing ends.

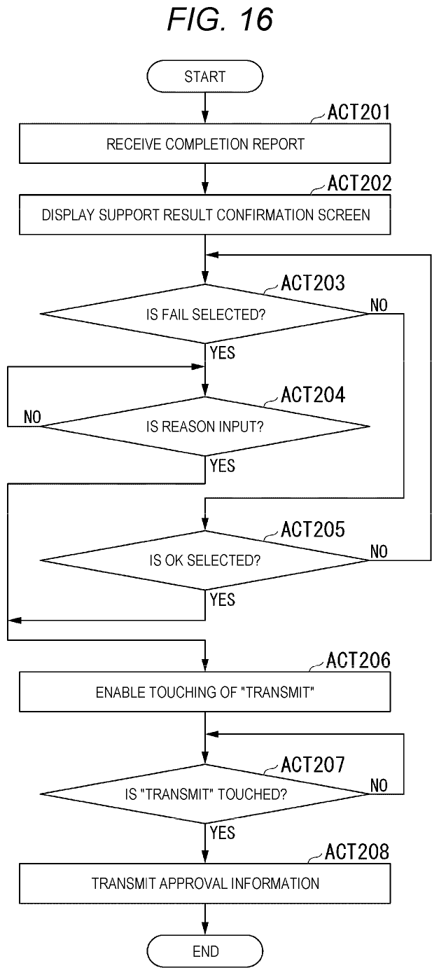

FIG. 16 is a flowchart showing a flow of processing of the mobile terminal 700. In FIG. 16, when receiving the completion report (ACT 201), the mobile terminal 700 displays the support result confirmation screen of the screen 1030 (ACT 202). The mobile terminal 700 determines whether “fail” is selected (ACT 203). If “fail” is selected, if the reason is input (YES in ACT 204), the processing proceeds to the next ACT 206.

In ACT 203, if it is determined that “fail” is not selected (NO in ACT 203), the mobile terminal 700 determines whether “OK” is selected (ACT 205). If “OK” is not selected (NO in ACT 205), the mobile terminal 700 returns to ACT 203. If “OK” is selected (YES in ACT 205), the mobile terminal 700 proceeds to ACT 206.

In ACT 206, the mobile terminal 700 enables touching of “transmit” on the screen 1030. For example, the mobile terminal 700 changes “transmit” from a grayed-out state to an active state. When “transmit” is touched (YES in ACT 207), the mobile terminal 700 transmits the approval information to the request management server 600 (ACT 208), and ends the processing. The mobile terminal 700 may enable receiving of input of the approval result or the reason until “transmit” is touched in ACT 207.

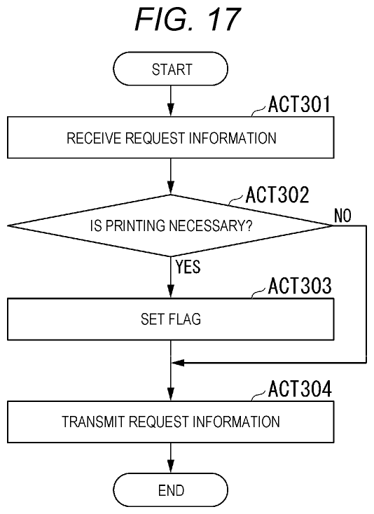

FIG. 17 is a flowchart showing a flow of processing of the request management server 600. When receiving the request information (ACT 301), the request management server 600 determines whether printing is necessary (ACT 302). Here, the calculation unit 620 described above calculates whether to cause the image forming apparatus 100 to print the request information, and the determination is made according to a result obtained by the calculation result. If it is not determined that the printing is necessary (NO in ACT 302), the request management server 600 proceeds to ACT 304. If it is determined that the printing is necessary (YES in ACT 302), the request management server 600 sets the flag (ACT 303). The request management server 600 transmits the request information to the image forming apparatus 100 (ACT 304), and ends the processing.

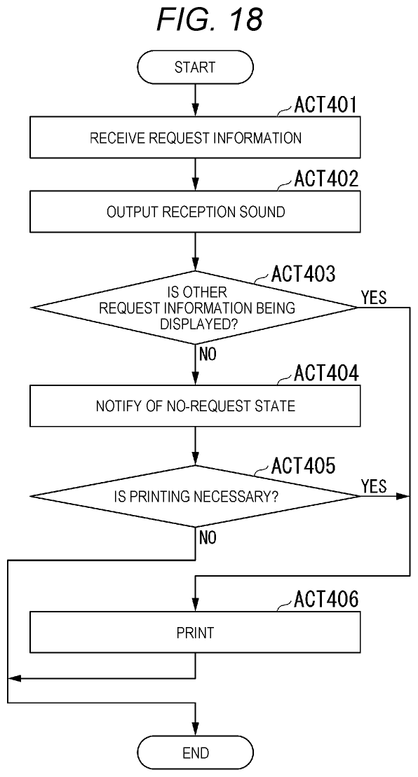

FIG. 18 is a flowchart showing a flow of processing of the image forming apparatus 100. When receiving the request information (ACT 401), the image forming apparatus 100 outputs the reception sound (ACT 402). The image forming apparatus 100 determines whether other request information is being displayed on the display 110 (ACT 403). When other request information is being displayed on the display 110 (YES in ACT 403), the image forming apparatus 100 prints the request information (ACT 406) and ends the processing.

If there is no other request information being displayed on the display 110 (NO in ACT 403), the image forming apparatus 100 first notifies of a no-request state indicating a state in which the request is not received at a current time point as the status information (ACT 404). Next, the image forming apparatus 100 determines whether the printing is necessary with reference to the flag (ACT 405). If the flag indicates that the printing is necessary (YES in ACT 405), the image forming apparatus 100 prints the request information (ACT 406) and ends the processing. If the flag does not indicate that the printing is necessary (NO in ACT 405), the image forming apparatus 100 ends the processing immediately. In the processing of FIG. 18, the image forming apparatus 100 may determine whether to print according to only the flag. In this case, the processing of ACT 403 is unnecessary.

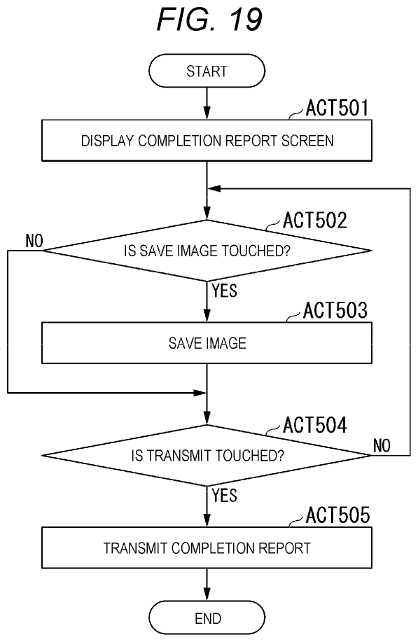

FIG. 19 is a flowchart showing a flow of processing of the image forming apparatus 100. The image forming apparatus 100 displays a completion report screen of the screen 1070 (ACT 501). The image forming apparatus 100 determines whether “save image” is touched (ACT 502). If “save image” is not touched (NO in ACT 502), the image forming apparatus 100 proceeds to ACT 504. If “save image” is touched (YES in ACT 502), the image forming apparatus 100 acquires and saves the image on the screen 1080 (ACT 503), and proceeds to ACT 504.

The image forming apparatus 100 determines whether “transmit” is touched (ACT 504). If “transmit” is not touched (NO in ACT 504), the image forming apparatus 100 returns to ACT 502. If “transmit” is touched (YES in ACT 504), the image forming apparatus 100 transmits the completion report to the request management server 600 (ACT 505) and ends the processing.

According to the embodiment described above, the work-from-home employee can make a request without determining the office employee asked for the work request, and therefore a time for making a request can be greatly reduced as compared with a case in the related art. In particular, since it is not easy for an employee who is newly assigned to the business office to search for the office employee asked for the work request, a technique according to the present embodiment is extremely suitable for the work-from-home employee.

Similarly, since the office employee can receive a request from anyone, the office employee can effectively use a gap of time in their work day. In addition, since the profit such as points is given, an incentive to support can be given, which leads to motivation of the office employee, and thus the office employee can handle more work faster. The points may be, for example, points that can be used in benefits, or maybe points that are advantageous in personnel evaluation.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. These embodiments and modifications thereof fall within the scope and spirit of the invention and are included in the scope of the invention recited in the claims and the equivalent thereof.

What is claimed is:

1. An image forming apparatus comprising:
a receiver configured to receive request information for requesting work from a work-from-home employee to an office employee working in a business office;
a display controller configured to display, on a display, work indicated by the request information received by the receiver; and
a selector configured to receive a selection of work to be performed by the office employee among the work indicated by the request information received by the receiver.

2. The apparatus according to claim 1, further comprising:
an acceptor configured to receive a completion report of the work selected by the selector; and
an acquirer configured to acquire an evaluation result obtained by evaluation performed by the work-from-home employee for the completion report received by the acceptor.

3. The apparatus according to claim 2, further comprising:
a giver configured to give, according to the evaluation result acquired by the acquirer, a profit to the office employee who completes the work.

4. The apparatus according to claim 2, wherein
the completion report includes an image showing a photograph of an aspect in which the work is performed.

5. The apparatus according to claim 4, wherein the image is uploaded via at least one of USB, Bluetooth, or scanning.

6. The apparatus of claim 1, further comprising a calculator configured to:
cause the image forming apparatus to print the request information; and
obtain a calculation result.

7. The apparatus of claim 1, further comprising:
a printer configured to print the request information;
a scanner configured to scan an image of the completed work;
a communicator configured to communicate with at least one other device; and
a controller configured to control each of the printer, the scanner, and the communicator.

8. A control method comprising:
receiving request information for requesting work from a work-from-home employee to an office employee working in a business office;
displaying, on a display, work indicated by the received request information; and
causing the office employee to select work to be performed by the office employee among the work indicated by the received request information.

9. The method of claim 8, further comprising:
completing the work by the office employee;
transmitting the work to a server;
approving, by the work-from-home employee, the completed work; and
generating a reward for the office employee.

10. The method of claim 8, further comprising:
receiving status information regarding the work selected by the office employee.

11. The method of claim 8, further comprising:
determining if the request information needs to be printed;
in response to determining the request information needs to be printed, setting a flag; and
printing, by the printer, the request information.

12. The method of claim 8, further comprising in response to receiving request information, outputting a reception sound.

13. The method of claim 8, further comprising:
receiving a completion report once the work has been completed by the office employee; and
transmitting the completion report to a server.

14. The method of claim 13, further comprising:
receiving an image of the completed work uploaded by the office employee; and
storing the image in the completion report.

15. The method of claim 14, wherein the image is uploaded via at least one of a USB, Bluetooth, or a scanner.

16. The method of claim 8, further comprising:
determining if fail has been selected by the work-from-home employee in response to the completion of the work;
prompting the work-from-home employee to input a reason for selecting fail; and
transmitting the input to a server.

17. The method of claim 16, further comprising:
in response to determining fail has been selected, selecting, by the work-from-home employee to receive support again;
marking the work support again; and
selecting by a second office employee the work marked support again.

18. A work-from-home employee support system comprising:
a mobile terminal configured to:
transmit request information for requesting work from a work-from-home employee to an office employee working in a business office;
an image forming apparatus comprising:
a receiver configured to receive request information,
a display controller configured to display, on a display, work indicated by the request information received by the receiver, and
a selector configured to cause the office employee to select work to be performed by the office employee among the work indicated by the request information received by the receiver; and
a request management server communicably coupled to each of the mobile terminal and the image forming apparatus.

19. The system of claim 18, wherein the request management server comprises a calculator configured to:
cause the image forming apparatus to print the request information; and
obtain a calculation result.

20. The system of claim 18, wherein the request management server is configured to:
receive a completion report from the image forming apparatus upon completion of the work; and
transmit the completion report to the mobile terminal.
